(19) United States
(12) Patent Application Publication
(10) Pub. No.: US 2008/0046265 A1
(43) Pub. Date: Feb. 21, 2008

(54) SYSTEM AND METHOD FOR CREATING AND MANAGING CONTRACTS FLEXIBLY

(75) Inventors: CHUNG-I LEE, Tu-Cheng (TW); XIN-YU HUANG, Shenzhen (CN); DONG-WEI JIN, Shenzhen (CN); LV-HONG WU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/757,399

(22) Filed: Jun. 4, 2007

(30) Foreign Application Priority Data
Aug. 18, 2006 (CN) 200610062198.1

(51) Int. Cl. G06Q 10/00

(52) U.S. Cl. 705/1

(57) ABSTRACT

A system for creating and managing contracts flexibly is provided. The system includes a server, a plurality of client computers connected to the server via a network and a database. The server is configured for receiving information of desired contracts from users on the client computers, obtaining contract templates in the database or creating contract templates based on information of the desired contract and for receiving feedback information from the users when the users apply the contract templates to complete the desired contracts. Furthermore, the server is configured for monitoring status of the completed desired contracts. A related method is also provided.

### BACKGROUND OF THE INVENTION

1. Field of the Invention

The present invention relates to systems and methods for creating and managing legal documents and, particularly, to a system and method for creating and managing contracts flexibly.

2. Description of Related Art

Contracts are frequently used in almost all areas, especially in commerce. Generally speaking, an enterprise is required to communicate with a variety of vendors, suppliers and service providers. In communication between various businesses, parties bring out various types of contracts, such as sale contracts, futures contracts, lease contracts, construction contracts and other types of contracts.

Traditionally, contracts were made manually, however, with the development of computer technology, electronic contracts began to replace traditional paper contracts and software programs have been adopted to manage the electronic contracts efficiently. Often, new contracts are created based on contract templates. A contract template is a template designed to cover essential requirements of the law, as well as common or typical practices of a particular type of contracts.

At present, a contract is typically created as follows: when a user (i.e. a sales department of an enterprise) needs to sign a new contract with a partner (i.e. a purchaser), the user requests a law department to provide a contract template; after the law department receives information about the request, a lawyer is appointed to draw the contract template based on information about the request and applicable laws; then the contract template is sent to the user, the user applies the contract template and signs the new contract.

An enterprise may have a large number of departments and different departments may use the same or similar contracts. Thus, a large number of contract templates may exist in the enterprise and the number may be ever increasing, upon every new request. However, many newly created contract templates are/will be of the same type and only have very subtle differences in comparison to the already existing contract templates. The result of manual contract drafting is impractical, a waste of time and a waste of human resources. In addition, the status of all kinds of contracts will need to be monitored manually. (i.e. status of when a contract would expire and status of whether the contract has been abated before expiring.)

What is needed, therefore, is a system and method for creating and managing contracts flexibly.

### SUMMARY OF THE INVENTION

A system for creating and managing contracts flexibly, according to a preferred embodiment, is provided. The system includes a server, a plurality of client computers connected to the server via a network and a database. The server is configured for receiving information of desired contracts from users on the client computers via the network, obtaining contract templates in the database or creating contract templates based on information of the desired new contract, and for receiving feedback information from the users when the users apply the contract templates to complete the desired contracts. Furthermore, the server is configured for monitoring status of the completed desired contracts.

Another preferred embodiment provides a method for creating and managing contracts flexibly. The method includes: (a) receiving information of a contract desired by a user from a computer, the information including a type of the desired contract, information of parties involved in the desired contract and detailed terms of the desired contract; (b) generating a contract template that meets the received information of the desired contract for the user to complete the desired contract; (c) storing the completed desired contract in the database; and (d) monitoring status of the completed desired contract and informing related persons of the status.

Other advantages and novel features of the present invention will become more apparent from the following detailed description when taken in conjunction with the accompanying drawings.

### BRIEF DESCRIPTION OF THE DRAWINGS

FIG. 1 is a schematic diagram illustrating a system for creating and managing contracts flexibly according to a preferred embodiment;

FIG. 2 is a block diagram illustrating function modules of a server in FIG. 1; and

FIG. 3 is a flowchart of a preferred method for creating and managing contracts flexibly.

### DETAILED DESCRIPTION OF THE PREFERRED EMBODIMENT

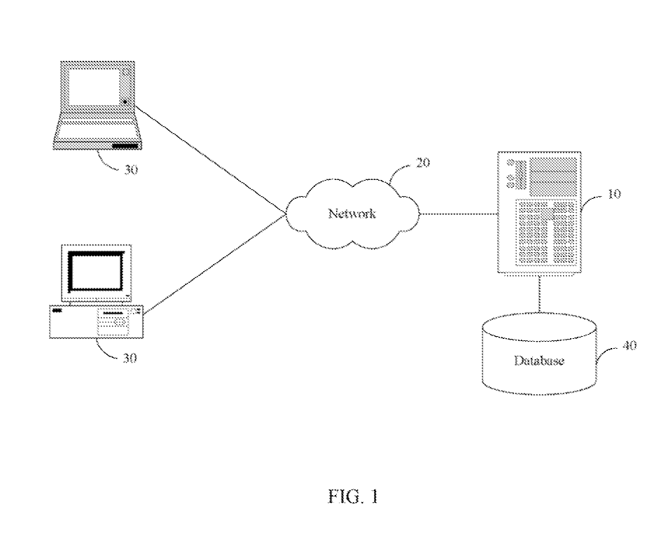

FIG. 1 is a schematic diagram illustrating a system for creating and managing contracts flexibly, according to a preferred embodiment. The system may include a server 10, a plurality of client computers 30 (only two shown) connected to the server 10 via a network 20 and a database 40.

The server 10 is configured for receiving information of contracts desired by users from the client computers 30, obtaining contract templates in the database 40 or creating contract templates based on information of corresponding desired contracts and receiving feedback information from the users when the users apply the contract templates to complete the desired contracts. Information of a desired contract may include a type of the desired contract, information of parties involved in the desired contract and detailed terms of the desired contract. The desired contracts may be sales contracts, futures contracts, lease contracts, construction contracts or other types of contracts. Furthermore, the server 10 is configured for monitoring status of the completed desired contracts.

The network 20 can be a local area network (LAN), a wide area network (WAN), a metropolis area network (MAN) or any other kind of network.

Each client computer 30 is programmed to provide an interactive user interface for users to submit information of desired contracts to the server 10, and view contract templates obtained from the database 40. Each client applies the contract templates to complete the desired contracts and each client computer 30 is further programmed to receive status information of the completed desired contracts.

The database 40 is configured for storing the contract templates, the information of the desired contracts and the completed desired contracts.

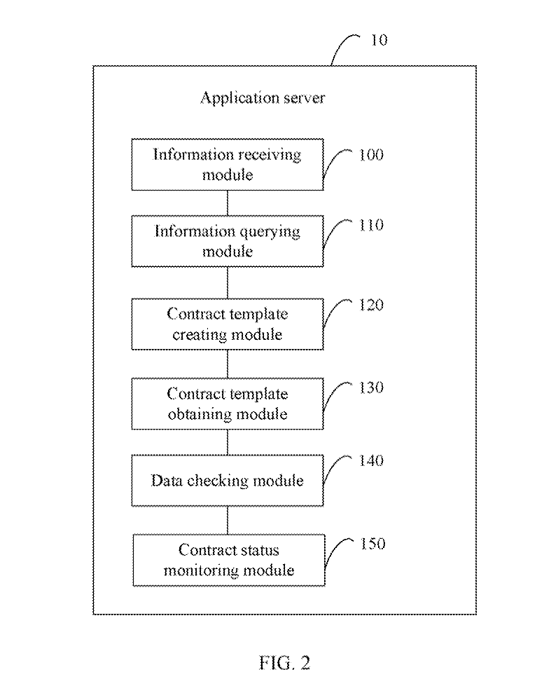

FIG. 2 is a block diagram illustrating function modules of the server 10. The server 10 typically includes: an information receiving module 100, an information querying module 110, a contract template creating module 120, a contract template obtaining module 130, a data checking module 140 and a contract status monitoring module 150.

The information receiving module 100 is programmed for receiving information of a desired contract, submitted by a user from a client computer 30, via the network 20. The information of the desired contract may include a type of the desired contract (i.e. a sales contract), information of parties involved in the desired contract (such as a manufacturer A and a purchaser B) and detailed terms of the desired contract (such as agreements about supply and demand of goods and prices of the goods made by the manufacturer A).

The information querying module 110 is programmed for querying whether there is a contract template in the database 40 that meets the needs of the type of contract that is desired.

The contract template creating module 120 is programmed for creating a contract template based on the information of the desired contract and storing the contract template into the database 40, if there is no contract template in the database 40 that meets the requirements of the type of the desired contract. Creating the contract template includes setting contract clauses, setting an allowable range of the contract clauses that can be modified by the user and setting data types that can be added to the contract template by the user.

The contract template obtaining module 130 is programmed for obtaining the contract template from the database 40.

The data checking module 140 is programmed for checking whether the data added to the contract template meets predetermined data types of the contract template when the user applies the contract template to complete the desired contract, for example, whether a date input by the user is in a predetermined “YYYY-MM-DD” type? Whether a name input by the user is in a predetermined character type?

The contract status monitoring module 150 is programmed for monitoring the status of the completed desired contract and informing the related persons located at the client computers 30 of the status.

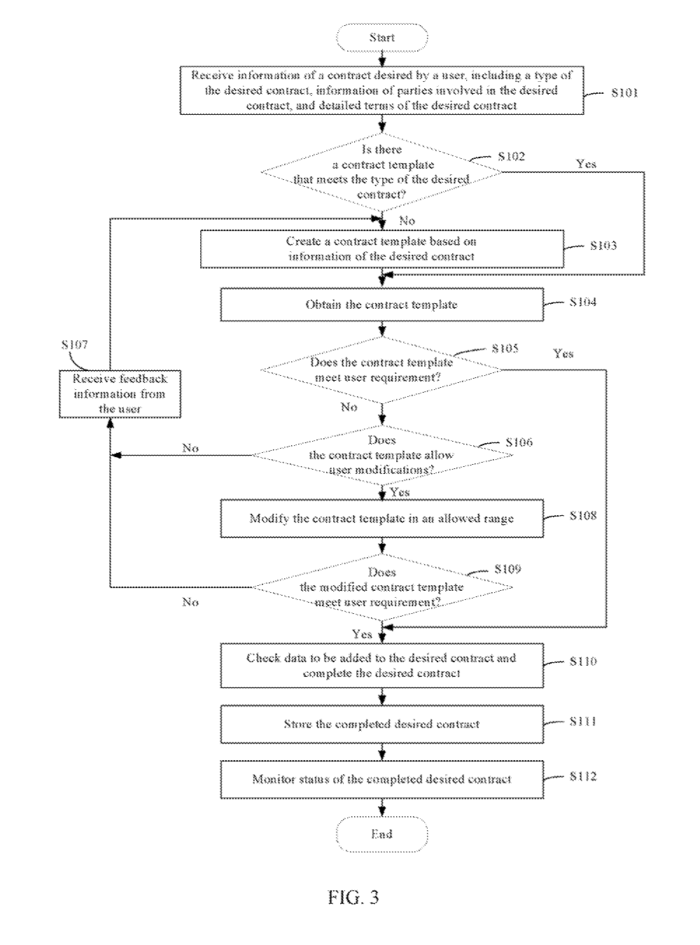

FIG. 3 is a flowchart of a preferred method for creating and managing contracts flexibly. First, a user (such as a manufacturer A) located at a client computer 30 submits information of a desired contract to the server 10. Upon submission of the desired contract to server 10, in step S101, the information receiving module 100 receives the information of the desired contract, including a type of the desired contract (i.e. sales contract), information of parties involved in the desired contract (such as the manufacturer A and a purchaser B) and detailed terms of the desired contract (such as agreements about supply and demand of goods and prices of the goods made by the manufacturer A).

In step S102, the information querying module 110 queries whether there is a contract template in the database 40 that meets the requirements of the type of the desired contract. If there is no contract template in the database 40 that meets the requirements of the type of the desired contract, then, in step 103, a contract administrator (i.e. a lawyer) at the server 10 creates a contract template based on the information of the desired contract through the contract template creating module 120, including setting contract clauses, setting an allowable range of the contract clauses that can be modified by the user, setting data types that can be added to the contract template by the user and storing the contract template in the database 40.

In step S102, if there is a contract template already in the database 40 that meets the requirements for the type of the desired contract, the procedure directly goes to step S104.

In step S104, the contract template obtaining module 130 obtains the contract template from the database 40 and sends the contract template to the client computer 30. In step S105, the user views the contract template and checks whether the contract template meets his/her requirement. For example, the user determines whether the contract clauses are in accordance with the agreements. If the contract template does not meet his/her requirement, in step S106, the data check module 140 checks whether certain contract clauses the user intends to modify may be allow to be modified.

If the contract clauses are not allowed to be modified, the user may send his opinion and suggestion to the server 10. Then, in step S107, the information receiving module 100 receives feedback information of the contract template from the user and the procedure returns to step S103.

In step S106, if the contract clauses allow the user to modify, the procedure goes to step S108, where the user modifies the contract clauses. After modifying the contract clauses, in step S109, the user views and checks the contract template again to determine whether the contract template meets his/her requirements. If the contract template still does not meet his/her requirements, the procedure goes back to step S107.

In step S109, if the contract template meets the user's requirements, the procedure goes to step S110, where the user applies the contract template to complete the desired contract. Applying the contract template to complete the desired contract involves actions such as inputting a valid date of the desired contract and signing his/her name electronically. Following step S110, the data checking module 140 checks whether the data added to the contract template meets the predetermined data type. If the data added by the user does not meet the predetermined data type, then the contract template would reject the data upon receiving until the user inputs the appropriate data type. The other user (i.e. the purchaser B) may also add data to the contract template and the data checking module 150 also checks the data added by the other user until the desired contract is completed.

In step S111, the user stores the completed desired contract in the database 40. In step S112, the contract status monitoring module 150 monitors the status of the completed desired contract. Monitoring the status involves: determining when the completed desired contract would expire and determining whether the completed desired contract has been abated before expiring. The contract status monitoring module 150 also sends the status information of the completed desired contract to the related persons, such as the manufacturer A and the purchaser B.

Although the present invention has been specifically described on the basis of a preferred embodiment and preferred method, it is to be understood that the invention is not limited thereto, the disclosure is illustrative only and various changes or modifications may be made in detail, especially in matters of size, shape and arrangement of parts with in the principles of the invention to the full extent indicated by the broad general meaning of the terms in which the appended claims are expressed. Changes or modifications may be made to the embodiments and methods without departing from the scope and spirit of the invention.

What is claimed is:

1. A computer-based method for creating and managing contracts flexibly comprising:
receiving information of a contract desired by a user from a computer, information including a type of the desired contract, information of parties involved in the desired contract and information of detailed terms of the desired contract;
generating a contract template that meets the received information of the desired contract for the user to complete the desired contract;
storing the completed desired contract in a database; and
monitoring status of the completed desired contract and informing related persons of the status of the completed desired contract.

2. The method as claimed in claim 1, wherein the generating step comprises:
querying whether there is a contract template already in the database that meets the type of the desired contract; and
obtaining the contract template directly from the database for the user to complete the desired contract, if there is a contract template in the database that meets the type of the desired contract.

3. The method as claimed in claim 2, further comprising:
creating a contract template based on the received information of the desired contract, if there is no contract template in the database that meets the type of the desired contract.

4. The method as claimed in claim 3, wherein the creating step comprises setting contract clauses, setting an allowable range of the contract clauses that can be modified by the user and setting data types that can be added to the contract template by the user.

5. A system for creating and managing contracts flexibly comprising a server, one or more client computers connected to the server and a database, wherein:
the database is configured for storing various contract templates and contracts;
each client computer provides an interactive interface for users to communicate with the server and obtain the contract templates or contracts; and
the server comprises:
an information receiving module for receiving information of a desired contract from a user;
an information querying module for querying whether there is a contract template in the database that meets a type of the desired contract;
a contract template creating module for creating a contract template based on the information of the desired contract, if there is not any contract template in the database that meets the type of the desired contract;
a contract template obtaining module for obtaining the contract template for the user to complete the desired contract; and
a contract status monitoring module for monitoring status of the completed desired contract and informing related persons of the status.

6. The system as claimed in claim 5, wherein the contract template creating module creates a contract template by setting contract clauses, setting an allowable range of the contract clauses that can be modified by the user and setting data types that can be added to the contract template by the user.
